(19) United States
(12) Patent Application Publication
(10) Pub. No.: US 2010/0100751 A1
(43) Pub. Date: Apr. 22, 2010

(54) Power Management Method for a Portable Computer System and Related Power Supply Device and Portable Computer System

(76) Inventors: Fu-Jyu Guo, Taipei Hsien (TW); Liang-Bin Chu, Taipei Hsien (TW); Yang Chou, Taipei Hsien (TW); Cheng-Wei Chang, Taipei Hsien (TW); Chi-Cheng Chang, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 12/581,863

(22) Filed: Oct. 19, 2009

(30) Foreign Application Priority Data
Oct. 20, 2008 (TW) 097140193

(51) Int. Cl. G06F 1/26

(52) U.S. Cl. 713/300

(57) ABSTRACT

A power management method for a portable computer system is disclosed. The portable computer system includes a plurality of power storage devices utilized for storing power and outputting a discharge current to the portable computer system. The power management method includes receiving a power and generating a corresponding charge current for charging a power storage device of the plurality of power storage devices, and comparing the discharge current and the charge current and adjusting power consumption of the portable computer system accordingly.

### BACKGROUND OF THE INVENTION

1. Field of the Invention

The present invention is related to a power management method for a portable computer system and related power supply device and portable computer system, and more particularly, to a power management method and related power supply device and portable computer system capable of extending utilization time.

2. Description of the Prior Art

Portable computer systems, such as notebook computers, personal digital assistants (PDAs), etc, have advantages of small size, lightweight, portability, etc, which allow users to work outside offices, to access functions of the computer systems, and no longer to be bounded in front of desks.

In general, a portable computer system includes a rechargeable battery, utilized for providing operating power, to accomplish portable operations. Since power stored in the rechargeable battery is limited, when power stored in the rechargeable battery is exhausted, the user has to replace the battery or apply other power sources, to continue using the portable computer system. However, in some cases, such as when the user does not bring excess batteries or cannot find an available power source, the user cannot use the portable computer system anymore.

In order to improve the above-mentioned situation, the prior art provide a method to use an energy converter which converts light or mechanical energy to electricity, so as to provide power to the portable computer system. However, the energy converter can only provide a dynamic power source, which may be insufficient to drive the portable computer system or just sufficient for charging the battery, and reduces utilization convenience.

In such a case, the prior art further provides another method to use at least two rechargeable batteries as the power source of the portable computer system. The main concept of such method is to separate charging and discharging operations. That is, when a rechargeable battery provides power to the portable computer system, the other is being charged. Therefore, the user can access functions of the portable computer system while performing charging. However, if a charge current is smaller than a discharge current, the portable computer system eventually turns out to be unavailable. Therefore, an improvement for the above power supply architecture having multiple batteries is necessary.

### SUMMARY OF THE INVENTION

It is therefore a primary objective of the claimed invention to provide a power management method for a portable computer system and related power supply device and portable computer system.

The present invention discloses a power management method for a portable computer system. The portable computer system comprises a plurality of power storage devices for storing power and outputting a discharge current to the portable computer system. The power management method comprises receiving a power, and generating a corresponding charge current, to charge a power storage device of the plurality of power storage devices, and comparing the discharge current and the charge current, and adjusting power consumption of the portable computer system accordingly.

The present invention further discloses a power supply device for a portable computer system, which comprises a plurality of power storage devices, for storing power and outputting a discharge current to the portable computer system, so as to drive the portable computer system, a charging device, for receiving a power, and generating a corresponding charge current, for charging a power storage device of the plurality of power storage devices, and a control device, for comparing the discharge current and the charge current, and adjusting power consumption of the portable computer system accordingly.

The present invention further discloses a portable computer system, which comprises a host, for performing operating functions, and a power supply device, comprising a plurality of power storage devices, for storing power and outputting a discharge current to the host, so as to drive the host, a charging device, for receiving a power, and generating a corresponding charge current, for charging a power storage device of the plurality of power storage devices, and a control device, for comparing the discharge current and the charge current, and adjusting power consumption of the host accordingly.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a portable computer system according to an embodiment of the present invention.

FIG. 2 illustrates a schematic diagram of a power management process according to an embodiment of the present invention.

FIG. 3A is a schematic diagram of an operating speed of a central processing unit of the portable computer system shown in FIG. 1.

FIG. 3B is a schematic diagram of variations of a discharge current and a charge current shown in FIG. 1.

### DETAILED DESCRIPTION

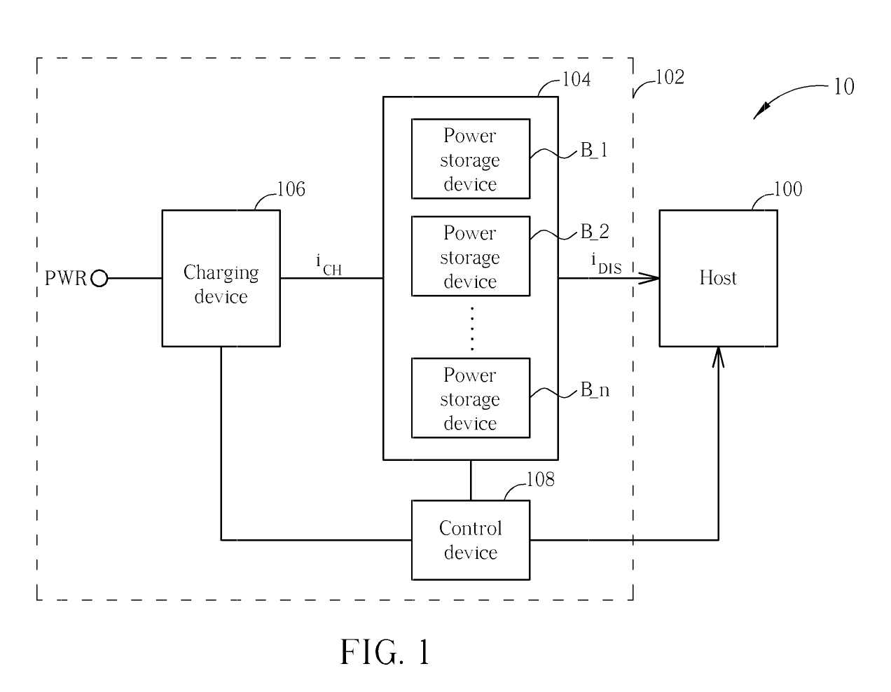

Please refer to FIG. 1, which is a schematic diagram of a portable computer system 10 in accordance with an embodiment of the present invention. The portable computer system 10 can be a notebook computer, a personal digital assistant (PDA), etc, and comprises a host 100 and a power supply device 102. The power supply device 102 is utilized for providing power for the host 100, to perform operating functions. The power supply device 102 comprises a power storage device set 104, a charging device 106 and a control device 108. The power storage device set 104 comprises power storage devices B_1˜B_n, utilized for storing power and outputting a discharge current i_{DIS} from a power storage device B_x to the host 100, so as to drive the host 100. The charging device 106 is utilized for receiving a power PWR, and generating a corresponding charge current i_{CH}, for charging another power storage device B_y. That is, in the power storage device set 104, the power storage devices (B_x, B_y) utilized for providing the discharge current i_{DIS} and for receiving the charge current i_{CH} are different. Besides, the control device 108 is utilized for comparing the discharge current i_{DIS} and the charge current i_{CH}, and adjusting power consumption of the host 100 accordingly.

In short, the power supply device 102 not only separates the charging and discharging operations, but also adjusts power consumption of the host 100 according to the comparison result of the charge current i_{CH} and the discharge current i_{DIS}. Preferably, when the discharge current i_{DIS} is greater than the charge current i_{CH}, the control device 108 can reduce power consumption of the host 100, to make the discharge current i_{DIS} equal to or smaller than the charge current i_{CH}. As a result, the present invention can make a charging speed equal to a discharging speed, to provide sufficient power for the host 100 successively, and ensure normal operations of the portable computer system 10. Note that, reducing power consumption of the host 100 is not limited in any specific way, and can be performed by reducing speaker volume, screen brightness, or an operating speed of a central processing unit (CPU), for example. Certainly, if the power PWR is sufficient, i.e. the discharge current i_{DIS} is smaller than the charge current i_{CH}, the present invention can recover previous configurations, to recover speaker volume, screen brightness, or CPU speed.

Therefore, if the power PWR is dynamic or with low current, such as power generated by a light or mechanical energy to electricity converter, the user can access functions of the portable computer system 10 while performing charging because the power storage devices performing dis-/charging in the power storage device set 104 are different. In addition, the control device 108 can adjust power consumption of the host 100 according to difference between the discharge current i_{DIS} and the charge current I_{CH}, to make dis-/charging speed the same or slow down discharging speed, so as to extend utilization time of the portable computer system 10.

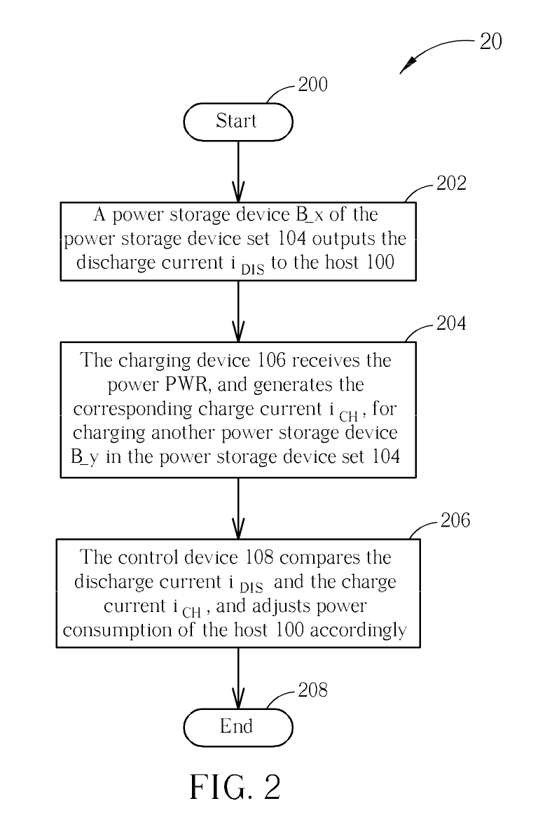

The operations of the power supply device 102 can be summarized in a power management process 20, as shown in FIG. 2. The power management process 20 comprises the following steps:

Step 200: Start.

Step 202: A power storage device B_x of the power storage device set 104 outputs the discharge current i_{DIS} to the host 100.

Step 204: The charging device 106 receives the power PWR, and generates the corresponding charge current I_{CH}, for charging another power storage device B_y in the power storage device set 104.

Step 206: The control device 108 compares the discharge current i_{DIS} and the charge current i_{CH}, and adjusts power consumption of the host 100 accordingly.

Step 208: End.

The detailed description of the power management process 20 is narrated above, and not given here.

Note that, the portable computer system 10 shown in FIG. 1 is a schematic diagram according to the embodiment of the present invention. Those skilled in the art can modify the portable computer system 10 according to different requirements. For example, the amount “n” of the power storage devices B_1˜B_n in the power storage device set 104 is not limited to a certain value as long as greater than or equal to 2. The method for adjusting power consumption of the host 100 is not limited to certain methods, and can be performed by adjusting speaker volume, screen brightness, or CPU speed, for example.

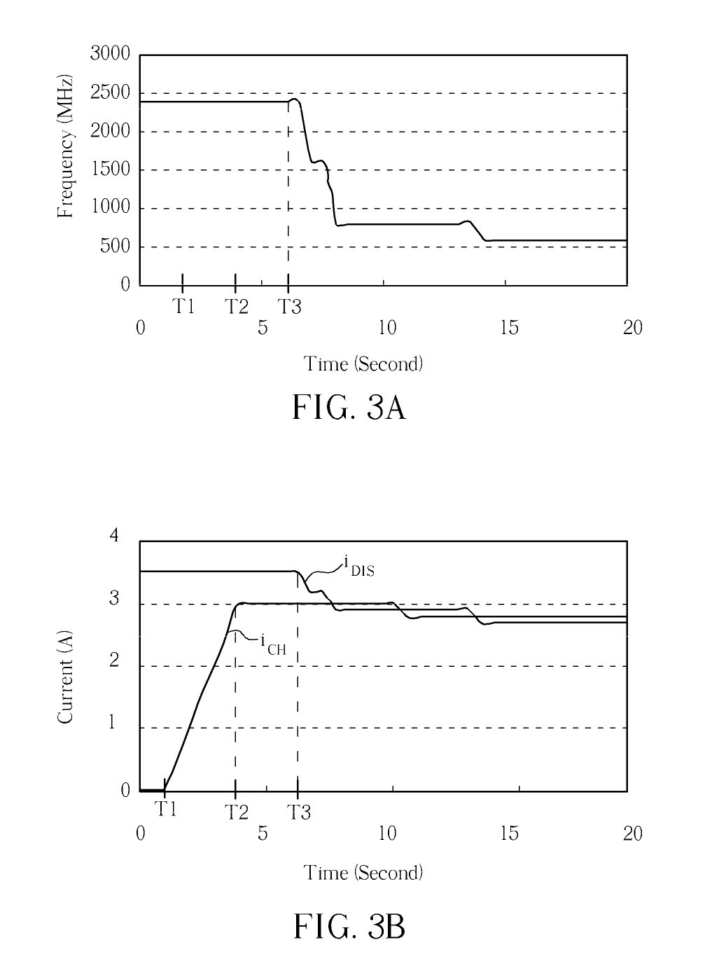

In order to clearly describe the operations of the power supply device 102, adjusting CPU speed is taken as an example below. Please refer to FIG. 3A and FIG. 3B. FIG. 3A is a schematic diagram of the CPU speed of the portable computer system 10, and FIG. 3B is a schematic diagram of variations of the discharge current i_{DIS} and the charge current i_{CH}. Assume that the portable computer system 10 uses about 3.5 A current in average, the CPU speed is 2.4 GMHz, and the portable computer system 10 is in a stable full-load status before the power PWR is provided. After the power PWR is provided, i.e. after time instant T1, the charge current i_{CH} starts increasing. When the charge current i_{CH} reaches a stable value (at time instant T2), the control device 108 stays for a while to make sure that the charge current i_{CH} is stable, and then reads the discharge current i_{DIS} and the charge current i_{CH} for performing comparison. At time instant T3, if the control device 108 detects that the discharge current i_{DIS} is greater than the charge current i_{CH}, the control device 108 informs a basic input/output system (BIOS) of the host 100 to lower down the CPU speed, so as to reduce the discharge current i_{DIS}. Then, repeat the procedure until the discharge current i_{DIS} is smaller than the charge current i_{CH}. Certainly, if the CPU speed is at lowest value while the discharge current i_{DIS} is still greater than the charge current i_{CH}, the control device 108 maintains the discharging and charging statuses. On the contrary, if the discharge current i_{DIS} is smaller than the charge current i_{CH}, the control device 108 increase the CPU speed gradually. Therefore, by adjusting the CPU speed, the control device 108 can adjust power consumption of the portable computer system 10, to make the discharge current i_{DIS} approaching to the charge current i_{CH}, so as to extend utilization time of the portable computer system 10.

Note that, FIG. 3A and FIG. 3B illustrate an embodiment of adjusting power consumption in the present invention. Other adjusting methods can be applied to the present invention.

To sum up, the present invention can improve power supply of a multi-battery system, and allow the user to access the functions of the portable computer system while performing charging. Meanwhile, the present invention can adjust power consumption of the portable computer system, to make the charging speed equal to the discharging speed or lower down the discharging speed, so as to extend utilization time.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A power management method for a portable computer system, the portable computer system comprising a plurality of power storage devices for storing power and outputting a discharge current to the portable computer system, the power management method comprising:
receiving a power, and generating a corresponding charge current, for charging a power storage device of the plurality of power storage devices; and
comparing the discharge current and the charge current, and adjusting power consumption of the portable computer system accordingly.

2. The power management method of claim 1, wherein an amount of the plurality of power storage devices is 2.

3. The power management method of claim 1, wherein the power is generated by a light energy to electricity converter.

4. The power management method of claim 1, wherein the power is generated by a mechanical energy to electricity converter.

5. The power management method of claim 1, wherein comparing the discharge current and the charge current and adjusting the power consumption of the portable computer system accordingly comprises reducing the power consumption of the portable computer system when the discharge current is greater than the charge current.

6. The power management method of claim 1, wherein comparing the discharge current and the charge current and adjusting the power consumption of the portable computer system accordingly is adjusting an operating speed of a central processing unit of the portable computer system, so as to adjust the power consumption of the portable computer system.

7. A power supply device for a portable computer system comprising:
A plurality of power storage devices, for storing power and outputting a discharge current to the portable computer system, so as to drive the portable computer system;
a charging device, for receiving a power, and generating a corresponding charge current, for charging a power storage device of the plurality of power storage devices; and
a control device, for comparing the discharge current and the charge current, and adjusting power consumption of the portable computer system accordingly.

8. The power supply device of claim 7, wherein an amount of the plurality of power storage devices is 2.

9. The power supply device of claim 7, wherein the power is generated by a light energy to electricity converter.

10. The power supply device of claim 7, wherein the power is generated by a mechanical energy to electricity converter.

11. The power supply device of claim 7, wherein the control device is utilized for reducing the power consumption of the portable computer system when the discharge current is greater than the charge current.

12. The power supply device of claim 7, wherein the control device is utilized for adjusting an operating speed of a central processing unit of the portable computer system, so as to adjust the power consumption of the portable computer system.

13. A portable computer system comprising:
a host, for performing operating functions; and
a power supply device, comprising:
a plurality of power storage devices, for storing power and outputting a discharge current to the host, so as to drive the host;
a charging device, for receiving a power, and generating a corresponding charge current, for charging a power storage device of the plurality of power storage devices; and
a control device, for comparing the discharge current and the charge current, and adjusting power consumption of the host accordingly.

14. The power supply device of claim 13, wherein an amount of the plurality of power storage devices is 2.

15. The power supply device of claim 13, wherein the power is generated by a light energy to electricity converter.

16. The power supply device of claim 13, wherein the power is generated by a mechanical energy to electricity converter.

17. The power supply device of claim 13, wherein the control device is utilized for reducing the power consumption of the host when the discharge current is greater than the charge current.

18. The power supply device of claim 13, wherein the control device is utilized for adjusting an operating speed of a central processing unit of the host, so as to adjust the power consumption of the host.
